(19) United States
(12) Patent Application Publication
(10) Pub. No.: US 2015/0032798 A1
(43) Pub. Date: Jan. 29, 2015

(54) Method And Apparatus For Providing Redundant Data Access

(71) Applicant: Alcatel-Lucent Canada Inc., Ottawa (CA)

(72) Inventor: Jeroen van Bemmel, Calgary (CA)

(73) Assignee: Alcatel-Lucent Canada Inc., Ottawa (CA)

(21) Appl. No.: 13/949,283

(22) Filed: Jul. 24, 2013

(51) Int. Cl. H04L 29/08

(52) U.S. Cl. CPC H04L 67/1008
USPC 709/203

(57) ABSTRACT

Various embodiments provide a method and apparatus for providing redundant data access. In particular, a response to a client request for a data item includes selecting the data segments of the data item to be provided to the client by each of a corresponding select plurality of servers. In particular, the data segments are smaller in size as compared to the data item and are configured such that the data item may be constructed using a proper subset of the transmitted data segments.

### TECHNICAL FIELD

The invention relates generally to methods and apparatus for providing redundant data access.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known redundant data access solutions, a client sends N requests to different servers, and processes the first response that is received in reply.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections.

Various embodiments provide a method and apparatus for providing redundant data access. In particular, a response to a client request for a data item includes selecting the data segments of the data item to be provided to the client by each of a corresponding select plurality of servers. In particular, the data segments are smaller in size as compared to the data item and are configured such that the data item may be constructed using a proper subset of the transmitted data segments.

In a first embodiment, an apparatus is provided for providing redundant data access. The apparatus includes a data storage and a processor communicatively connected to the data storage. The processor is programmed to: select a data item; determine a plurality of data segment requests based on the data item and an encoding algorithm; determine a plurality of servers corresponding to the plurality of data segment requests; and transmit the plurality of data segment requests to the corresponding plurality of servers.

In a second embodiment, a system is provided for providing redundant data access. The system includes a plurality of clients, a plurality of servers and a controller communicatively connected to the plurality of clients and the plurality of servers. At least one of the clients is configured to requests a data item. At least each of a select plurality of the servers is configured to: store at least one of the data item or a data segment associated with the data item. The controller is programmed to: select the data item based on the data item request from the at least one client; determine a plurality of data segment requests based on the data item and an encoding algorithm; determine a plurality of target servers corresponding to the plurality of data segment requests, the plurality of target servers being a subset of the plurality of servers; and transmit the plurality of data segment requests to the corresponding plurality of target servers.

In a third embodiment, a method is provided for providing redundant data access. The method includes: selecting a data item; determining a plurality of data segment requests based on the data item and an encoding algorithm; determining a plurality of servers corresponding to the plurality of data segment requests; and transmitting the plurality of data segment requests to the corresponding plurality of servers.

In a fourth embodiment, a non-transitory computer-readable storage medium is provided for storing instructions which, when executed by a computer, cause the computer to perform a method. The method includes: selecting a data item; determining a plurality of data segment requests based on the data item and an encoding algorithm; determining a plurality of servers corresponding to the plurality of data segment requests; and transmitting the plurality of data segment requests to the corresponding plurality of servers.

In some of the above embodiments, the plurality of data segment requests are configured such that an expected set of data segments being received from the plurality of servers in response to the plurality of data segment requests are such that the data segment members of the expected set of data segments are smaller in size as compared to the data item and the data item may be constructed using a proper subset of the expected set of data segments.

In some of the above embodiments, the encoding algorithm includes separating the data item into a number of literal data segments and one or more data segments which are logically related to two or more of the literal data segments.

In some of the above embodiments, the processor is further programmed to select, or the method further includes selecting: the encoding algorithm based on an estimated optimization of the bit patterns sent across the network.

In some of the above embodiments, the processor is further programmed to select, or the method further includes selecting the encoding algorithm based on one or more system characteristics.

In some of the above embodiments, the encoding algorithm comprises a data segment size based on the one or more system characteristics.

In some of the above embodiments, the encoding algorithm is based on a plurality of workloads corresponding to at least a portion of the plurality of servers.

In some of the above embodiments, the processor is further programmed to select, or the method further includes selecting: the encoding algorithm based exchanging one or more messages with at least one of the plurality of servers.

In some of the above embodiments, the plurality of data segment requests include an encoding algorithm directive.

In some of the above embodiments, the processor is further programmed, or the method further includes: receiving a plurality of server responses from the plurality of servers; and constructing the data item from the plurality of servers responses based on a decoding algorithm. Where the plurality of server responses is a proper subset of a total expected set of server responses.

In some of the above embodiments, the select plurality of servers are further configured to: receive one of the plurality of data segment requests; determine a server response based on the one data segment request and a data segment encoding algorithm; and transmit the server response to the controller.

In a fifth embodiment, an apparatus is provided for providing redundant data access. The apparatus includes a data storage and a processor communicatively connected to the data storage. The processor being programmed to: select a data item; determine a plurality of data segments based on the data item and an encoding algorithm; determine at least one server corresponding to the plurality of data segment requests; and transmit the plurality of data segments to the at least one corresponding plurality of servers.

In some of the above embodiments, the processor is further programmed, or the method further includes: receiving a second plurality of data segments from at least one second server; and constructing a second data item based on the second plurality of data segments and a decoding algorithm. Where the second plurality of data segments are a proper subset of a total set of data segments associated with the second data item.

### BRIEF DESCRIPTION OF THE DRAWINGS

Various embodiments are illustrated in the accompanying drawings, in which:

FIG. 1 illustrates an embodiment of a redundant data access system 100 for providing redundant data access;

FIG. 2 depicts a flow chart illustrating an embodiment of a method 200 for a redundant data access system (e.g., system 100 of FIG. 1) to provide redundant data access;

FIG. 3 depicts a flow chart illustrating an embodiment of a method 300 for a controller (e.g., controller 140 of FIG. 1) to transmit “N” determined server requests as illustrated in step 240 of FIG. 2;

FIG. 4 depicts a flow chart illustrating an embodiment of a method 400 for a client or controller (e.g., one of clients 120 or controller 140 of FIG. 1) to reconstruct a data item as illustrated in step 280 of FIG. 2; and

FIG. 5 schematically illustrates an embodiment of various apparatus 500 such as one of clients 120, one of servers 130 or controller 140 of FIG. 1.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, the various embodiments described herein are not necessarily mutually exclusive, as some embodiments may be combined with one or more other embodiments to form new embodiments.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

Various embodiments provide a method and apparatus for providing redundant data access. In particular, a response to a client request for a data item includes selecting the data segments of the data item to be provided to the client by each of a corresponding select plurality of servers. In particular, the data segments are smaller in size as compared to the data item and are configured such that the data item may be constructed using a proper subset of the transmitted data segments.

Advantageously, by reconstructing the data item using a proper subset of the transmitted data segments, the response may have increased robustness and latency characteristics as the data item may be constructed prior to receipt of lost or delayed data segments. Moreover, the total transmission time may be reduced, as data segments may be sent in parallel over their respective communication paths.

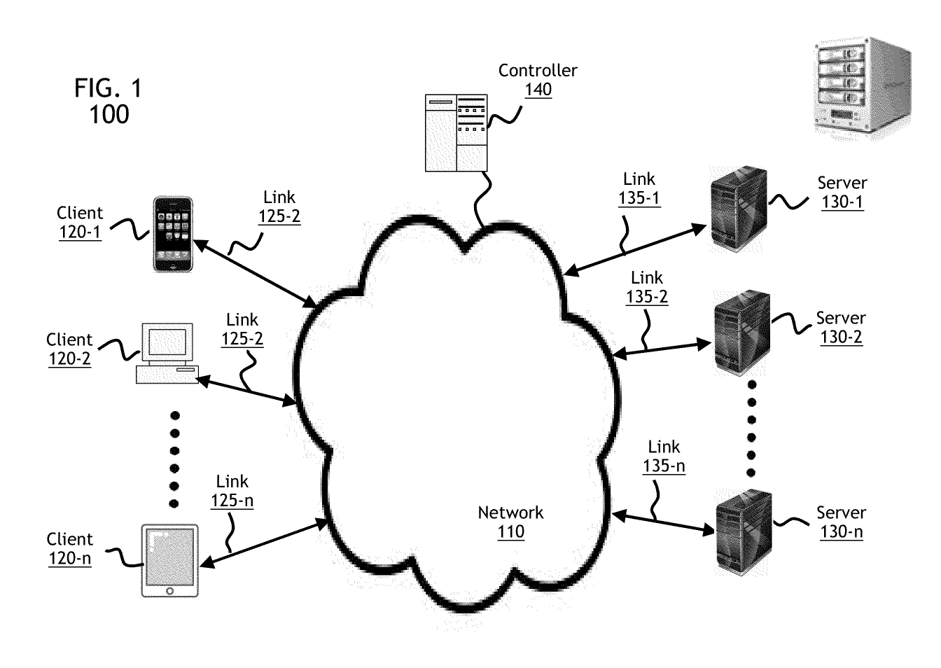

FIG. 1 illustrates an embodiment of a redundant data access system 100 for providing redundant data access. The redundant data access system 100 includes one or more clients 120-1-120-n (collectively, clients 120) accessing one or more data items (not shown for clarity) residing on one or more servers 130-1-130-n (servers 130) through a communication flow established over a communication path. Where the storage of the one or more data items or the accessing of the one or more data items is controlled by controller 140. The communication path includes an appropriate one of links 125-1-125-n (collectively, links 125), network 110, and an appropriate one of links 135-1-135-n (collectively, links 135).

As defined herein, a “data item” is broadly construed as any suitable data that may be transmitted between a client and a server such as, for example: a file, a web page, a data stream or a message. Moreover, as defined herein, a “data segment” is broadly construed as data that represents all or a portion of a data item in normal or encoded form.

The network 110 includes any number of access and edge nodes and network devices and any number and configuration of links. Moreover, it should be appreciated that network 110 may include any combination and any number of wireless, or wire line networks including: LTE, GSM, CDMA, Local Area Network(s) (LAN), Wireless Local Area Network(s) (WLAN), Wide Area Network (WAN), Metropolitan Area Network (MAN), or the like.

Clients 120 may include any type of communication device(s) capable of sending or receiving information (e.g., packets) over network 110 via one or more of links 125. For example, a communication device may be a thin client, a smart phone (e.g., client 120-1), a personal or laptop computer (e.g., client 110-1), server, network device, tablet (e.g., client 120-n), television set-top box, media player or the like. Communication devices may rely on other resources within the exemplary system to perform a portion of tasks, such as processing or storage, or may be capable of independently performing tasks. It should be appreciated that while three clients are illustrated here, system 100 may include fewer or more clients. Moreover, the number of clients at any one time may be dynamic as clients may be added or subtracted from the system at various times during operation.

Links 125 and 135 support communicating over one or more communication channels such as: wireless communications (e.g., LTE, GSM, CDMA, Bluetooth); WLAN communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, communication channels 125 and 135 may be any number or combinations of communication channels.

Servers 130 may include any suitable device capable of storing data items or data segments and sending or receiving information (e.g., packets) over network 110 via one or more of links 135.

Controller 140 may be any suitable device capable of selecting the data segments of the data item to be provided to a client (e.g., client 120-1) by each of a corresponding select plurality of servers 130. In particular, the data segments are smaller in size as compared to the data item and are configured such that the data item may be constructed using a proper subset of the transmitted data segments.

It should be appreciated that while only one controller is illustrated here, system 100 may include more controllers. It should be further appreciated that though illustrated as connected to clients 120 and 130 through network 110, controller 140 may be positioned in any suitable configuration within system 100. It should be even further appreciated that though illustrated as a separate device, the controller may be within one or more of clients 120 or servers 130 (e.g., controller functionality may be distributed between one or more clients, servers or controllers).

In some embodiments of controller 140, the controller is positioned between clients 120 and network 110. For example, the controller may be an edge device or a device within a data center. In one of these embodiments, the controller receives a client request, determines a number of server data segment requests based on the client request, transmits each of the server data segment requests to a selected server, receives the responses from the servers and assembles the requested data item when the controller has received suitable content segments from at least a portion of the responding servers.

In some embodiments of controller 140, the controller is within one or more of clients 120.

In some embodiments of controller 140, the controller is within one or more of servers 130.

In some embodiments of controller 140, the controller is at least partially distributed within one or more of clients 120 or one or more of servers 130.

In some embodiments, the controller 140 communicates with the servers providing the data segments by transmitting information to each of the select servers that identifies what data segment the selected server is to provide.

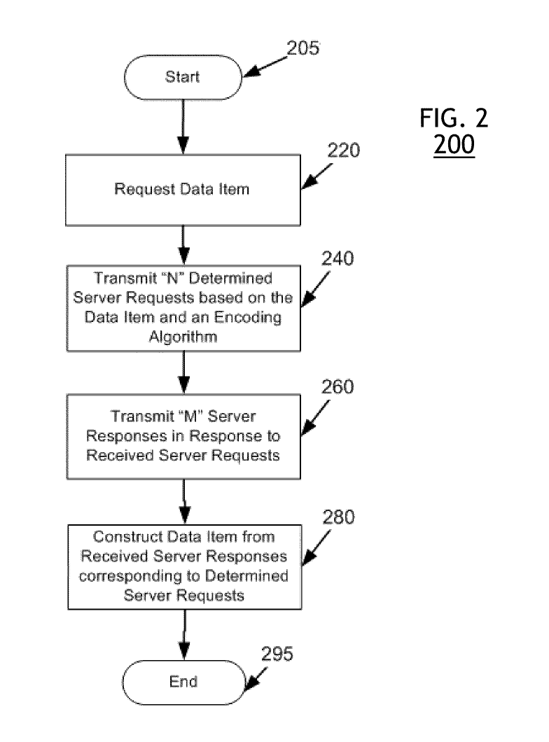

FIG. 2 depicts a flow chart illustrating an embodiment of a method 200 for a redundant data access system (e.g., system 100 of FIG. 1) to provide redundant data access. The method begins at step 205 and includes: requesting a data item (step 220); transmitting “N” determined server requests based on the data item and an encoding algorithm (step 240); transmitting “M” server responses in response to received server requests (step 260); constructing a data item from received server responses corresponding to determined server requests (step 280); and the method ends at step 395.

In the method 200, step 220 includes requesting a data item (e.g., by one of clients 120 of FIG. 1). In particular, an apparatus performing the method receives a data item retrieval trigger event and initiates a request to retrieve the identified data item. A data item retrieval trigger event may be any suitable event identifying a data item to be retrieved such as: (i) receiving a request from a user interface (e.g., such as a prompt for a web page on a client device); (ii) determining a data item required to perform an action (e.g., from an application determining a requirement to retrieve a data item such as downloading a file for use); or (iii) the like. A request to retrieve the identified data item may be any suitable method for retrieving a data item from a source such as, for example: (i) sending a request to a server or controller over a network (e.g., one or more of servers 130 or controller 140 of FIG. 1 requesting a web page via the HTTP protocol over network 110 of FIG. 1); (ii) sending a request via an internal communication channel (e.g., a client communicating with a controller within the same data center or device via internal communication channels); or (iii) the like.

In the method 200, step 240 includes transmitting “N” determined server requests (e.g., by controller 140 of FIG. 1 to “N” of server 130 of FIG. 1) based on the data item and an encoding algorithm. In particular, an algorithm is used to determine a set of data segments to represent the requested data item and a set of corresponding servers to which to direct respective requests for each of the selected set of data segments. For example, a data item consisting of the four bytes “0xA5C3” may be represented by three data segments, A, B, and A⊕B. Where A is a data segment representing one half of the data item (e.g., “0xA5”), B is a data segment representing the other half of the data item (e.g., “0xC3”), and data segment A⊕B represents the bit-wise exclusive or of data segments A and B (e.g., 0x66). Furthermore, since the algorithm selects three data segments to represent the data item, “N” may be three and requests may be sent to three different servers requesting each of the respective data segments.

In the method 200, step 260 includes transmitting “M” server responses (e.g., by “M” of server 130 of FIG. 1) in response to the received server requests transmitted in step 240. In particular, each of a subset of the servers receiving a server request for a data item responds by providing the requested data segment. It should be appreciated that since the data item may be constructed by using a proper subset of data segments, “M” may be less than or equal to “N” (e.g., if one of the servers did not receive its corresponding server request).

In the method 200, step 280 includes constructing a data item (e.g., by the controller 140 or one of clients 120 of FIG. 1) from server responses received in step 260. In particular, the apparatus performing the method step constructs the data item once the apparatus receives a proper subset of data segments which are sufficient to construct the data item. For example, using the example above, the apparatus may construct the data item after receiving any two data segments of the set {A, B, A⊕B}.

In some embodiments of the step 260, one or more of the servers (e.g., servers 130 of FIG. 1) store the data item and one or more data segments related to the data item.

In some embodiments of the step 260, one or more servers store only the data item. It should be appreciated that the one or more servers may then determine the requested data segment upon receipt of a server request. In some of these embodiments, the server may then store a data segment after it has processed request to reduce processing costs upon a future request for the same data segment. In a further embodiment, the storage of the data segments may be deleted upon an event such as available storage falling below a threshold or an age since last request.

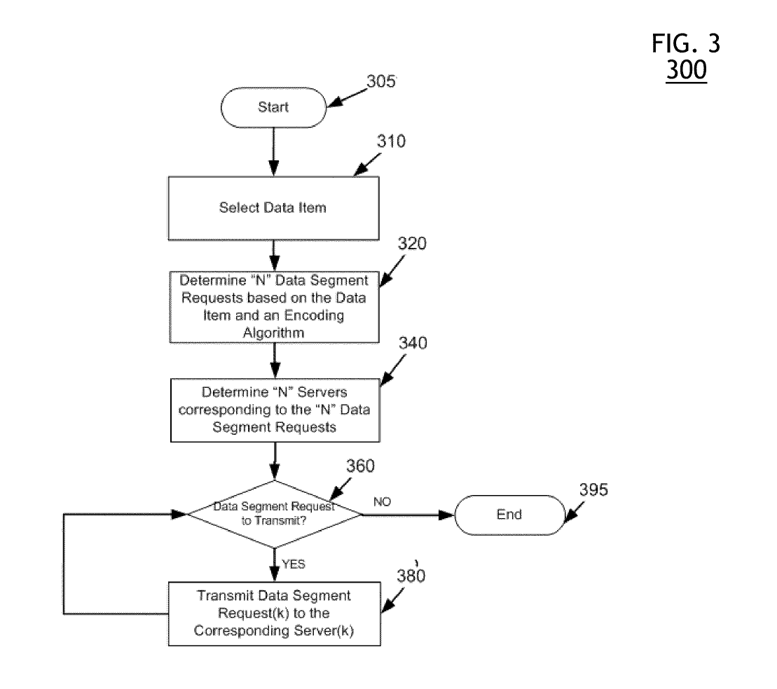

FIG. 3 depicts a flow chart illustrating an embodiment of a method 300 for a controller (e.g., controller 140 of FIG. 1) to transmit “N” determined server requests as illustrated in step 240 of FIG. 2. The method begins at step 305 and includes: selecting a data item (step 310); determining “N” data segment requests based on the data item and an encoding algorithm (step 320); determining “N” servers corresponding to the “N” data segments (step 340); and transmitting each of the selected “N” data segment requests to a corresponding server (step 380) while it is determined that data segment requests should be transmitted (step 360). The method ends at step 395.

In the method 300, step 310 includes selecting a data item. Data item selection may include any suitable method such as, for example: (i) receiving a request from a client (e.g., client 120-1 of FIG. 1) specifying a data item; (ii) receiving a request from a user interface (e.g., such as on a client device); (iii) determining a data item required to perform an action (e.g., from an application determining a requirement to retrieve a data item); or (iv) the like.

In the method 300, step 320 includes determining “N” data segment requests based on the data item and an encoding algorithm. In particular, the set of “N” data segment requests are determined such that the set of data segments resulting from the data segment requests provide a set of data segments that are smaller in size as compared to the data item and are configured such that the data item may be constructed using a proper subset of the data segments.

In the method 300, step 340 includes determining “N” servers corresponding to the “N” data segment requests. In particular, a server is selected to respond with a corresponding data segment for each of the “N” data segment requests. Servers may be selected based on any suitable method including: (i) random selection; (ii) round robin selection; (iii) using quality of service metrics (e.g., latency); (iv) using cost metrics; (v) using path or resource diversity considerations (e.g., to minimize the risk of multiple data segments being lost on a congested or failed link or component); or (vi) the like. It should be appreciated that one server may be selected to serve more than one data segment.

In the method 300, step 360 includes determining whether there are any data segment requests to transmit. If the apparatus performing the method has data segment requests to transmit, the method proceeds to step 380, else the method ends at step 395. The determination may include any suitable method such as: (i) determining that all of the data segment requests have been transmitted; (ii) determining that sufficient data segments have been received to construct the data item; or (iii) the like.

In the method 300, step 380 includes transmitting a data segment request determined in step 320 to a corresponding server determined in step 340 using conventional transmission techniques.

In some embodiments of the step 320, the determination includes retrieving information regarding the data item. Information regarding the data item may be retrieved by any suitable method such as: (i) a message exchange with a server hosting the data item; (ii) a message exchange with a management system responsible for the data item; or (iii) the like.

In some embodiments of the step 320, the determination includes retrieving information regarding the system. Information regarding the system may be any suitable information such as: (i) quality of service parameters such as latency of communication paths in the network; (ii) cost parameters such as storage cost, network costs or processing costs of system components; (iii) transmission parameters such as transmission protocol; or (iv) the like.

In some embodiments of the step 320, the encoding algorithm includes separating the data item into a number of literal data segments and one or more data segments which are logically related to two or more of the literal data segments. In some of these embodiments, the data item is divided into “X” literal data segments and “Y” logically related data segments. In some of these embodiments, X=2 and Y=1. In some other embodiments, X=3 and Y=2. Logically related data segments may be determined from literal data segments using any suitable algorithm such as: (i) bytewise operations such as addition or subtraction of literal data segments; (ii) bitwise operators such as subtraction or exclusive-or of literal data segments; or (iii) the like.

In some embodiments of the step 320, the encoding algorithm includes selecting an encoding algorithm based on an estimated optimization of the bit patterns sent across the network. For example, if sending mostly 0 bits is advantageous, a comparison may be done between a number of encoding algorithms and selecting the algorithm that has the calculated higher percentage of 0 bits in the resulting patterns.

In some embodiments of the step 320, the encoding algorithm includes selected an encoding algorithm based on one or more system characteristics such as transmission unit characteristics. In some of these embodiments, the data segment size may be based on system parameters in order to reduce packet fragmentation overhead on the network. For example, some Ethernet networks use a standard MTU (Maximum Transmission Unit) of 1500 bytes. By encoding 5000 bytes of content as 4 data segments of 1500 bytes each, the same amount of 4 data segments are sent (5000/1500 rounded up), mitigating the bandwidth overhead. As another example, the switching fabric in some routers is designed for certain optimal cell sizes (e.g. 128 bytes). By encoding to a multiple of such a cell size, the forwarding overhead in routers across the network may be reduced. As a third example, storage devices (e.g. disk drives) may use a certain block size for storage (e.g. 4096 bytes); by encoding for such a block size, the read efficiency for those disks may be improved. Similarly, cache sizes of clients and intermediate buffer sizes of network elements may be the basis for determining the data segment size.

In some embodiments of the step 320, the encoding algorithm includes selecting an encoding algorithm based on server workloads. In some of these embodiments, selection is based on selecting servers based on cost. For example, servers with less expensive CPUs, storage or network bandwidth may be selected. In this example. if a selected server configuration is capable of delivering data at 1 Gbps and a given application uses large files of 10 Gb which must be delivered within 5 seconds, the encoding algorithm may be selected such that the data item is encoded into 3 data segments of which 2 are needed to reconstruct the data item. It should be appreciated that the two responding servers may then meet the given quality of service deadline (i.e., 5 Gb delivered per server/1 Gbps server deliver speed=5 seconds).

In some embodiments of the step 320, the data segment request includes only a data item identifier (e.g., a name identifying the data item such as a URL or a file name). In some of these embodiments, the servers are configured such that servers only store one data segment of the data item. For example, a data segment request of retrieve {http://www.alcatel-lucent.com/} where the server only stores the “B” data segment of the data item, requests the “B” data segment from the server.

In some embodiments of the step 320, the data segment request includes a data item identifier (e.g., a name identifying the data item such as a URL or a file name) and an encoding algorithm directive. The encoding algorithm directive may be any suitable directive that provides information to the server on how to encode the data item to provide a specific data segment. In some embodiments, the encoding algorithm directive may be an index of a known data segment. For example, a data segment request of retrieve {http://www.alcatel-lucent.com/, “2”} where an encoding algorithm is set that uses {A, B, A+B}, specifies for the server to return the “B” data segment of the data item. In some other embodiments, the encoding algorithm directive may be an index into a table of data segment encoding algorithms such as {N/2(1), N/2(2), N/2(1+2)} where the “2” selection specifies a data segment algorithm of N/2(2) which may equate to the aforementioned “B” data segment encoding of the data item. In some embodiments of the step 320, the encoding algorithm directive specifies an encoding algorithm for the server to determine the data segment. For example, a data segment request of retrieve {http://www.alcatel-lucent.com/, “N/2(1+2)”} may specify for the server to return the bytewise addition of the first half and second halves of the data item. It should be appreciated that any suitable protocol may be used to specify a particular data segment encoding algorithm to be applied against the data item.

In some embodiments of the step 320, the data segment request includes a directive to encode the data item on a repetitive block basis. In particular, an encoding algorithm is applied on a portion of the data item instead of the entire data item. For example, for a data item (e.g., a video) that is 2 M bytes, an {A, B, A+B} encoding algorithm may be applied to every 1000 bytes. Advantageously, a streaming data item may realize improved latency and robustness by encoding the data item on a repetitive basis.

In some embodiments of steps 360 and 380, data segment requests are transmitted in parallel.

In some embodiments of steps 360 and 380, one or more data segment requests are resent. In some of these embodiments, a data segment request is resent to a different server (i.e., the apparatus performing the method returns to step 340 to determine at least one server corresponding to the resent data segment request). In some of these embodiments, the resent data segment request is sent to a server from which a previous successful server response has been received. Advantageously, retrying a failed request to a server from which a response was successfully received may improve performance.

In a further embodiment, the data segment request being resent is based on a determination that one of the data segment requests is a failed request. In some of these embodiments, the data segment request retry is based on exceeding a time threshold associated with the receipt of the first successful server response. In one such embodiment, a timestamp T1 is determined upon transmission of a data segment request (e.g., the start of step 360 or upon transmission of the first or last data segment request in step 380). A second timestamp T2 is determined after fully receiving the first server response from any server. The data segment request retry is then based on a determination that one or more server responses have not been received after a period based on the algorithm: T1+150% *(T2−T1).

In some embodiments of resending one or more data segment requests where the transmission protocol is HTTP, the existing TCP connection is reused.

In some embodiments of resending one or more data segment requests, the controller is configured to receive a server response where the data segment is transmitted in a different order. In some of these embodiments, the order is a reverse order. For example, for a data segment of N bytes, the transmission of the bytes of a resent data segment request is in reverse order (i.e. starting from byte N−1). Advantageously, a partially received response from another server can be more rapidly constructed (e.g., as described in step 460 below).

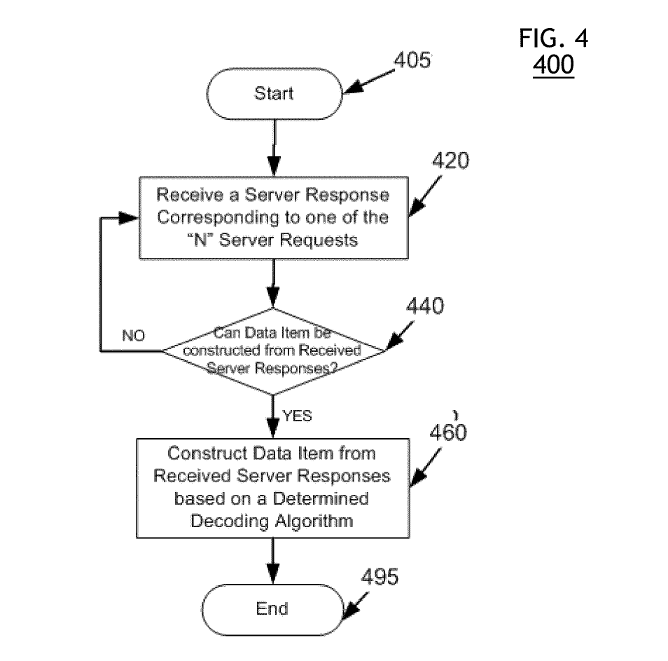

FIG. 4 depicts a flow chart illustrating an embodiment of a method 400 for a client or controller (e.g., one of clients 120 or controller 140 of FIG. 1) to reconstruct a data item as illustrated in step 280 of FIG. 2. The method includes: receiving a server response corresponding to one of “N” server requests that had been previously transmitted (step 420); constructing a data item from the received server responses based on a determined decoding algorithm (step 460) if a determination is made that the data item may be constructed from the received server responses or returning to step 420 to receive another server response (step 440). The method ends at step 495.

In the method 400, step 420 includes receiving a server response corresponding to one of “N” server requests that had been previously transmitted (e.g., 380 of FIG. 3). In particular, the server response includes a data segment that was specified in the corresponding server request.

In the method 400, step 440 includes determining whether a data item may be constructed from the received server responses. If a data item may be constructed, the method proceeds to step 460, else the method proceeds to step 420. It should be appreciated that the determination may also include a timeout or error routines that proceed to step 495.

In the method 400, step 460 includes constructing a data item from the received server responses based on a determined decoding algorithm. In particular, the decoding algorithm is based on the encoding algorithm and the data segments received in step 420. For example, using an encoding algorithm of {A, B, A+B}, any combination of 2 data segments ({A,B}, {A,A+B} or {B,A+B}) is sufficient to reconstruct the requested data item. In particular, {A,B} is a simple concatenation of the 2 data segments, and {A,A+B} can be constructed by observing that B=(A+B)−(A), i.e. by doing a byte-wise subtraction of the two received blocks. Similarly, {B,A+B} can be constructed by observing that A=(A+B)−(B).

Referring to FIGS. 3 and 4, in a first example where the encoding algorithm contains X=2 literal data segments and Y=1 logically related data segments, an HTML web page consisting of 1000 ASCII characters may be encoded as 3 data segments of 500 bytes each. Where A is the first 500 bytes, B is the second 500 bytes, and C is a bytewise addition of data segments A and B (e.g., A+B). In this example, a controller may request data segments A, B and A+B from 3 different servers render the page as soon as any 2 requests are received. Advantageously, though this scheme may require 50% increased storage, the scheme can potentially improve transmission latency by a factor of 2/1 while allowing 1/3 of requests to fail or be delayed.

In a second example where the encoding algorithm contains X=3 literal data segments and Y=2 logically related data segments, an HTML web page consisting of 1200 ASCII characters may be encoded as 5 data segments of 400 bytes each such as: {A, B, C, A+B−C, A−B+C}. Where A is the first 400 bytes, B is the second 400 bytes, C is the final 400 bytes, and A+B-C and A-B+C are bytewise manipulations of data segments A, B and C. In this example, a controller may request data segments A, B, C, A+B−C and A−B+C from 5 different servers render the page as soon as any 3 requests are received. It can be observed that any combination of 3 data segments is sufficient to reconstruct the original page. Advantageously, though this scheme may require 67% increased storage, the scheme can potentially improve transmission latency by a factor of 3/1 while allowing 2/5 of requests to fail or be delayed.

Although primarily depicted and described in a particular sequence, it should be appreciated that the steps shown in methods 300, 400 or 500 may be performed in any suitable sequence. Moreover, the steps identified by one step may also be performed in one or more other steps in the sequence or common actions of more than one step may be performed only once.

Although primarily shown where data items are data storage, it should be appreciated that in some embodiments, data items may be messages sent between devices. For example, in one such embodiment, a message (e.g., a request) is encoded as a number of segments (e.g., such as three segments encoded using {A, B, A⊕B}) and sent to a server. Similar to embodiments where data items are data storage, such encoding may advantageously allow for 33% packet loss and reduce delay variations when packets are routed along different paths. In some of these embodiments, the messages are transmitted between a mobile handset and a base over a wireless network.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

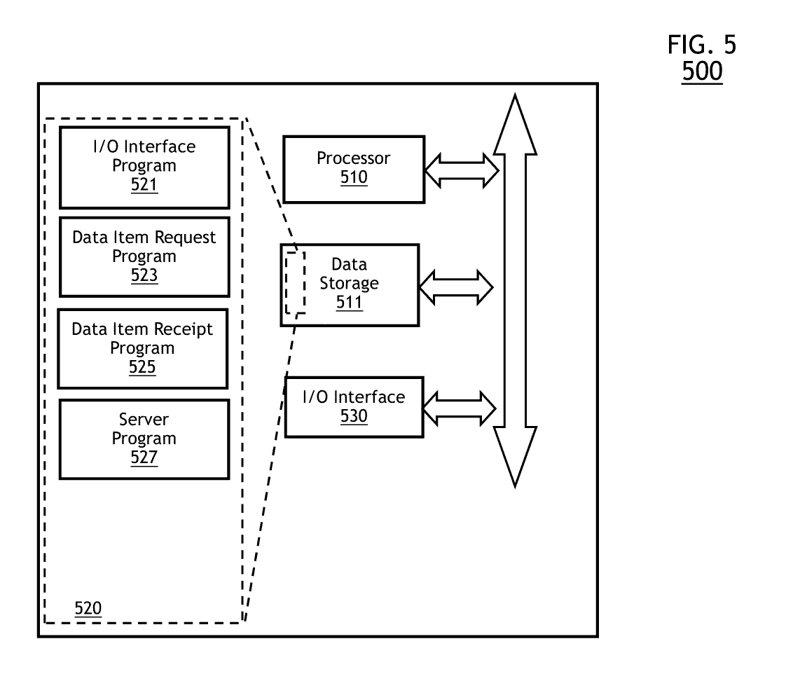

FIG. 5 schematically illustrates an embodiment of various apparatus 500 such as one of clients 120, one of servers 130 or controller 140 of FIG. 1. The apparatus 500 includes a processor 510, a data storage 511, and optionally an I/O interface 530.

The processor 510 controls the operation of the apparatus 500. The processor 510 cooperates with the data storage 511.

The data storage 511 stores programs 520 executable by the processor 510. Data storage 511 may also optionally store program data such as data items, encoding algorithms, or the like as appropriate.

The processor-executable programs 520 may include an I/O interface program 521, a data item request program 523, a data item receipt program 525 or a server program 527. Processor 510 cooperates with processor-executable programs 520.

The I/O interface 530 cooperates with processor 510 and I/O interface program 521 to support communications over links 125 or 135 of FIG. 1 as appropriate and described above. The I/O interface program 521 performs one or more of the steps 240 or 260 of FIG. 2, 310 or 380 of FIG. 3, or 420 of FIG. 4 as described above and as appropriate.

The data item request program 523 performs one or more of the steps 220 or 240 of FIG. 2 or the steps of the method 300 of FIG. 3 as described above and as appropriate.

The data item receipt program 525 performs one or more of the steps 280 of FIG. 2 or the steps of the method 400 of FIG. 3 as described above and as appropriate.

The server program 527 performs one or more of the step 260 of FIG. 2 as described above and as appropriate.

In some embodiments, the processor 510 may include resources such as processors/CPU cores, the I/O interface 530 may include any suitable network interfaces, or the data storage 511 may include memory or storage devices. Moreover the apparatus 500 may be any suitable physical hardware configuration such as: one or more server(s), blades consisting of components such as processor, memory, network interfaces or storage devices. In some of these embodiments, the apparatus 500 may include cloud network resources that are remote from each other.

In some embodiments, the apparatus 500 may be one or more virtual machine (s). In some of these embodiments, one or more of the virtual machine(s) may include components from different machines or be geographically dispersed. For example, the data storage 511 and the processor 510 may be in two different physical machines.

When processor-executable programs 520 are implemented on a processor 510, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus for providing redundant data access, the apparatus comprising:
a data storage; and
a processor communicatively connected to the data storage, the processor being configured to:
select a data item;
determine a plurality of data segment requests based on the data item and an encoding algorithm;
determine a plurality of servers corresponding to the plurality of data segment requests; and
transmit the plurality of data segment requests to the corresponding plurality of servers.

2. The apparatus of claim 1, wherein the plurality of data segment requests are configured such that an expected set of data segments being received from the plurality of servers in response to the plurality of data segment requests are such that the data segment members of the expected set of data segments are smaller in size as compared to the data item and the data item may be constructed using a proper subset of the expected set of data segments.

3. The apparatus of claim 1, wherein the encoding algorithm includes separating the data item into a number of literal data segments and one or more data segments which are logically related to two or more of the literal data segments.

4. The apparatus of claim 1, wherein the processor is further configured to select the encoding algorithm based on an estimated optimization of the bit patterns sent across the network.

5. The apparatus of claim 1, wherein the processor is further configured to select the encoding algorithm based on one or more system characteristics.

6. The apparatus of claim 5, wherein the encoding algorithm comprises a data segment size based on the one or more system characteristics.

7. The apparatus of claim 5, wherein the encoding algorithm is based on a plurality of workloads corresponding to at least a portion of the plurality of servers.

8. The apparatus of claim 1, wherein the processor is further configured to select the encoding algorithm based exchanging one or more messages with at least one of the plurality of servers.

9. The apparatus of claim 1, wherein the plurality of data segment requests comprise an encoding algorithm directive.

10. The apparatus of claim 1, wherein the processor is further configured to:
receive a plurality of server responses from the plurality of servers; and
construct the data item from the plurality of servers responses based on a decoding algorithm;
wherein the plurality of server responses is a proper subset of a total expected set of server responses.

11. A system for providing redundant data access, the system comprising:
a plurality of clients, at least one of the clients configured to:
request a data item;
a plurality of servers, each of a select plurality of the servers configured to:
store at least one of the data item or a data segment associated with the data item; and
a controller communicatively connected to the plurality of clients and the plurality of servers, the controller configured to:
select the data item based on the data item request from the at least one client;
determine a plurality of data segment requests based on the data item and an encoding algorithm;
determine a plurality of target servers corresponding to the plurality of data segment requests, the plurality of target servers being a subset of the plurality of servers; and
transmit the plurality of data segment requests to the corresponding plurality of target servers.

12. The system of claim 11, wherein the select plurality of servers are further configured to:
receive one of the plurality of data segment requests;
determine a server response based on the one data segment request and a data segment encoding algorithm; and
transmit the server response to the controller.

13. A method for providing redundant data access, the method comprising:
at a processor communicatively connected to a data storage, selecting a data item;
determining, by the processor in cooperation with the data storage, a plurality of data segment requests based on the data item and an encoding algorithm;
determining, by the processor in cooperation with the data storage, a plurality of servers corresponding to the plurality of data segment requests; and
transmitting, by the processor in cooperation with the data storage, the plurality of data segment requests to the corresponding plurality of servers.

14. The method of claim 13, wherein the plurality of data segment requests are configured such that an expected set of data segments being received from the plurality of servers in response to the plurality of data segment requests are such that the data segment members of the expected set of data segments are smaller in size as compared to the data item and the data item may be constructed using a proper subset of the expected set of data segments.

15. The method of claim 13, wherein the encoding algorithm includes separating the data item into a number of literal data segments and one or more data segments which are logically related to two or more of the literal data segments.

16. The method of claim 13, further comprising: selecting, by the processor in cooperation with the data storage, the encoding algorithm based exchanging one or more messages with at least one of the plurality of servers.

17. The method of claim 13, further comprising:
receiving a plurality of server responses from the plurality of servers; and
constructing the data item from the plurality of servers responses based on a decoding algorithm;
wherein the plurality of server responses is a proper subset of a total expected set of server responses.

18. A non-transitory computer-readable storage medium storing instructions which, when executed by a computer, cause the computer to perform a method, the method comprising:
selecting a data item;
determining a plurality of data segment requests based on the data item and an encoding algorithm;
determining a plurality of servers corresponding to the plurality of data segment requests; and
transmitting the plurality of data segment requests to the corresponding plurality of servers.

19. An apparatus for providing redundant data access, the apparatus comprising:
a data storage; and
a processor communicatively connected to the data storage, the processor being configured to:
select a data item;
determine a plurality of data segments based on the data item and an encoding algorithm;
determine at least one server corresponding to the plurality of data segment requests; and
transmit the plurality of data segments to the at least one corresponding plurality of servers.

20. The apparatus of claim 19, wherein the processor is further configured to:
receive a second plurality of data segments from at least one second server; and
construct a second data item based on the second plurality of data segments and a decoding algorithm;
wherein the second plurality of data segments are a proper subset of a total set of data segments associated with the second data item.
